(19) United States
(12) Patent Application Publication
(10) Pub. No.: US 2007/0248884 A1
(43) Pub. Date: Oct. 25, 2007

(54) NEGATIVE ELECTRODE AND SECONDARY BATTERY

(76) Inventor: Kenji Tsuchiya, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/688,557

(22) Filed: Mar. 20, 2007

(30) Foreign Application Priority Data
Mar. 30, 2006 (JP) P2006-095609

(51) Int. Cl. H01M 4/58

(52) U.S. Cl. 429/231.4; 429/128

(57) ABSTRACT

There is provided a negative electrode including a negative electrode current collector and a negative electrode active material layer provided on the negative electrode current collector. In the negative electrode, the negative electrode active material layer includes a first layer having contact with the negative electrode current collector, and a second layer formed on the first layer. Further, the first and second layers are formed of carbon materials capable of inserting and extracting lithium. A specific surface area of a carbon material forming the second layer is larger than a specific surface area of a carbon material forming the first layer, and a thickness of the first layer corresponds to from 40% or more to 90% or less of a thickness of the entire negative electrode active material layer.

### CROSS REFERENCES TO RELATED APPLICATIONS

The present invention contains subject manner related to Japanese Patent Application JP 2006-095609 filed in the Japanese Patent Office on Mar. 30, 2006, the entire contents of which being incorporated herein by reference.

### BACKGROUND OF THE INVENTION

1. Field of the Invention

The present invention relates to a negative electrode using carbon materials, and a secondary battery using the negative electrode.

2. Description of the Related Art

In recent years, due to reduction in size and weight of electronic apparatus such as mobile communication apparatus, notebook personal computers, palmtop personal computers, integrated video cameras, portable CD (MD) players and cordless telephones, batteries having a compact structure and large in capacity have been desired as power supplies used for the electronic apparatus.

Primary batteries such as alkaline-manganese batteries, and secondary batteries such as nickel-cadmium batteries and lead storage batteries have generally been used as power supplies of these electronic apparatuses.

In particular, non-aqueous electrolyte secondary batteries represented by lithium-ion secondary batteries using lithium composite oxides for the positive electrodes and using carbon-based materials capable of inserting and extracting lithium ions for the negative electrodes have been widely used owing to compactness in volume and lightness in weight, and capability in extracting high voltage and obtaining high energy density.

Non-aqueous electrolyte secondary batteries having such structure, reduction in charging time has been expected for improving usability of the batteries.

Non-aqueous electrolyte secondary batteries in the related art, the charging time is reduced by charging the batteries when a high battery load is applied. However, if a charge-discharge cycle is repeated in the high battery load application, lithium ion insertion reaction in a negative electrode does not uniformly occur in the entire negative electrode, but intensively occurs on the surface of the negative electrode, so that metal lithium is precipitated on the surface of the negative electrode where the lithium ion insertion reaction has intensively occurred. Decomposition reaction of an electrolytic solution is caused due to the precipitation of the metal lithium, thereby deactivating the lithium ion insertion reaction. Thus, the battery capacity gradually decreases when a high battery load is applied. Accordingly, the improvement in charge-discharge cycle characteristics may be desired when a high battery load is applied.

According to an embodiment of the present invention, the specific surface area of a negative electrode active material may be increased for improving charge-discharge cycle characteristics when a high battery load is applied. For example, graphite particles having a large specific surface area may be used as a negative electrode active material.

However, the specific surface area of negative electrode graphite particles involves an initial irreversible capacity and thermal stability of a negative electrode. For example, when the specific surface area of graphite particles is large, the initial irreversible capacity may increase, thereby deceasing thermal stability. Thus, it may not be preferable to increase the specific surface area of negative electrode graphite particles in view of an increase in the capacity and the safety of a battery.

Japanese Patent Application Publication No. 2004-127913, for example, discloses a secondary battery having an excellent charge-discharge cycle characteristics that is produced by mixing two types of graphite having different specific surface areas to form a negative electrode active material layer.

### SUMMARY OF THE INVENTION

However, satisfactory charge-discharge cycle characteristics may not be obtained when a high battery load is applied by simply mixing two types of graphite having different specific surface areas due to insufficient high-load charge characteristics.

According to an embodiment of the present invention, there are provided a negative electrode having an excellent charge-discharge cycle characteristics when a high battery load is applied and a secondary battery using the negative electrode.

According to an embodiment of the present invention, there is provided a negative electrode that includes a negative electrode current collector and a negative electrode active material layer in which

the negative electrode active material layer includes a first layer having contact with the negative electrode current collector and a second layer formed on the first layer;

the first and second layers are formed of carbon materials capable of inserting and extracting lithium;

a specific surface area of a carbon material forming the second layer is larger than a specific surface area of a carbon material forming the first layer; and a thickness of the first layer corresponds to 40% or more to 90% or less of a thickness of the entire negative electrode active material layer.

According to an embodiment of the present invention, there is provided a secondary battery that includes

a positive electrode,

a negative electrode and

an electrolyte in which

the negative electrode is includes a negative electrode current collector and a negative electrode active material layer; the negative electrode active material layer includes a first layer having contact with the negative electrode current collector and a second layer formed on the first layer;

the first and second layers are formed of carbon materials capable of inserting and extracting lithium;

the specific surface area of the carbon material forming the second layer is larger than the specific surface area of the carbon material forming the first layer; and

the thickness of the first layer corresponds to from 40% or more to 90% or less of the thickness of the entire negative electrode active material layer.

A negative electrode according to an embodiment of the present invention employs a first layer formed of a carbon material having a small specific surface area in combination with a second layer formed of a carbon material having a large specific surface area, thereby not increasing the specific surface area as the entire negative electrode. Thus, the structure of the negative electrode in an embodiment of the present invention may control a decrease in the thermal stability caused by an increase in the specific surface area of the negative electrode. Further, precipitation of lithium on the surface of the negative electrode caused by a high-load charge-discharge cycle may be controlled by using a carbon material having a large specific surface area on the side of the negative electrode surface.

The negative electrode according to an embodiment of the present invention includes a negative electrode active material layer having a thickness of the first layer that corresponds to 40% or more to 90% or less of a thickness of the entire negative electrode active material layer so that a decrease in the thermal stability of the negative electrode and precipitation of lithium on the surface of the negative electrode may both be controlled by adjusting the specific surface area of the negative electrode active material layer.

The secondary battery according to an embodiment of the present invention includes a negative electrode having a first and a second layers in which a thickness of the first layer corresponds to 40% or more to 90% or less of a thickness of the entire negative electrode active material layer so that a decrease in the thermal stability of the negative electrode when subjected to a high-load charge-discharge cycle may be controlled, and decomposition reaction of an electrolytic solution on the negative electrode surface may also be controlled by controlling precipitation of lithium on the surface of the negative electrode.

A negative electrode according to an embodiment of the present invention includes a first layer formed of a carbon material having a small specific surface area and a second layer formed of a carbon material having a large specific surface area so that the negative electrode may exhibit an excellent cycle characteristics.

According to a secondary battery in an embodiment of the present invention, decomposition reaction of an electrolytic solution when a high battery load is applied may improve charge-discharge cycle characteristics. Thus, although the capacity of the battery is increased, high-speed charge by high-load charge may still be performed, thereby improving usability of the battery.

### BRIEF DESCRIPTION OF THE DRAWINGS

FIG. 1 is a configuration diagram of a battery using an electrode winding body according to an electrode of an embodiment of the present invention.

FIG. 2 is a sectional view showing a configuration of the electrode winding body in FIG. 1 along the line I-I.

### DESCRIPTION OF THE PREFERRED EMBODIMENTS

Embodiments of the present invention will be described below by referring to the drawings.

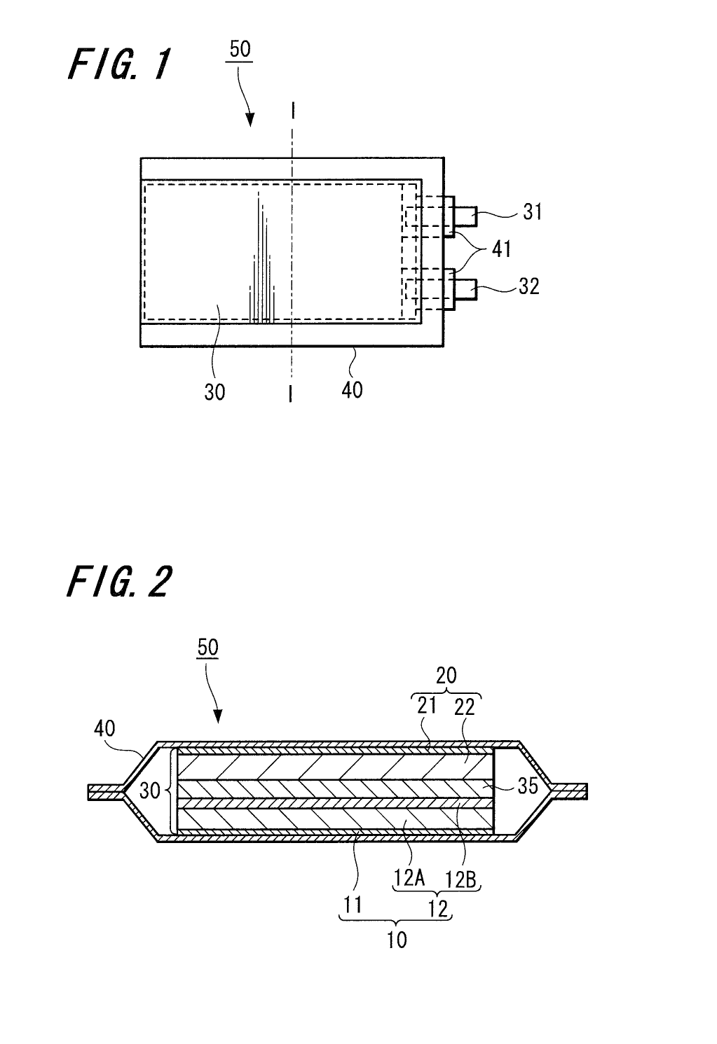

FIG. 1 shows a configuration diagram of a battery according to an embodiment of the present invention.

A secondary battery 50 according to an embodiment of the present invention includes an electricity-generating element 30 to which a positive electrode lead 31 and a negative electrode lead 32 are attached is encapsulated in a film-form exterior member 40.

FIG. 2 is a sectional view showing a configuration of the electrode winding body in FIG. 1 along the line I-I.

The electricity-generating element 30 used in the secondary battery 50 of the present invention is configured such that a positive electrode 20 and a negative electrode 10 are stacked via a gel-form electrolyte 35 interposed inbetween.

The positive electrode 20 includes a positive electrode current collector 21, and a positive electrode active material layer 22 provided on the positive electrode current collector 21. The negative electrode 10 includes a negative electrode current collector 11, and a negative electrode active material layer 12 provided on the negative electrode current collector 11. The negative electrode active material layer 12 has a first layer 12A formed on the negative electrode current collector 11, and a second layer 12B formed on the first layer 12A.

The electricity-generating element 30 is configured such that the positive electrode 20 and the negative electrode 10 and the gel-form electrolyte 35 are stacked in a manner that the positive electrode active material layer 22 and the second layer 12B of the negative electrode active material layer 12 are mutually faced via the gel-form electrolyte 35 interposed inbetween.

The secondary battery 50 is configured such that the electricity-generating element 30 is encapsulated in the exterior member 40, which is then sealed under reduced pressure.

It is preferable that the negative electrode current collector 11 have excellent electrochemical stability, electric conductivity and mechanical strength, and formed of a metal material such as copper (Cu), nickel (Ni), stainless steel, and the like.

The negative electrode active material layer 12 has the first layer 12A and the second layer 12B.

The first layer 12A is formed on the current collector of the negative electrode, and the second layer 12B is formed on the first layer 12A.

As the negative electrode active material which forms the negative electrode active material layer 12, any carbon materials capable of inserting and extracting lithium may be used. As examples of the negative electrode active material include carbon-based materials such as non-graphitizable carbon, artificial graphite, natural graphite, pyrolytic carbons, cokes (pitch coke, needle coke, petroleum coke and the like), graphites, glass-form carbons, organic high-molecular compound burned substances (carbonized substances formed by burning phenolic resins, furan resins or the like at a certain temperature), carbon fibers, activated carbon and carbon blacks. Further, an electroconductive agent such as a vapor-grown carbon fiber or carbon black, and a binder such as polyvinylidenefluoride or styrene-butadiene resin may optionally be additionally used.

The thickness of the first layer 12A and the second layer 12B is preferably, it is preferable that the thickness of the first layer correspond to from 40% or more to 90% or less, more preferably 50% or more to 90% or less of the thickness of the entire negative electrode active material layer.

If the thickness of the first layer 12A is less than 40%, the specific surface area of the entire negative electrode increases with an increase in the initial irreversible capacity, thereby decreasing thermal stability and safety.

If the thickness of the first layer 12A is more than 90%, lithium ion insertion reaction in the negative electrode does not uniformly occur in the entire negative electrode but intensively occurs specifically on the surface of the negative electrode, so that metal lithium is precipitated on the surface of the negative electrode where the reaction intensively occurs and the metal lithium precipitation causes decomposition reaction of an electrolytic solution, thereby causing a decrease in capacity and a decrease in cycle characteristics.

It is preferable that the specific surface area of the carbon material of the first layer 12A be 1.0 m²/g or less. If the specific surface area exceeds 1.0 m²/g, the specific surface area of the entire negative electrode increases to allow the initial irreversible capacity to increase, thereby decreasing thermal stability and safety.

It is also preferable that the specific surface area of the carbon material of the second layer 12B be greater than 1.0 m²/g and 6.0 m²/g or less.

If the specific surface area is 1.0 m²/g or less, lithium ion insertion reaction does not uniformly occur at the entire negative electrode, and the precipitation of metal lithium causes cycle characteristics to decrease when a high battery load is applied.

If the specific surface area exceeds 6.0 m²/g, the specific surface area of the entire negative electrode increases to allow the initial irreversible capacity to increase, thereby decreasing thermal stability and the safety of the battery owing to gaseous expansion or the like caused by heat by charge and discharge when the battery is stored at high-temperature.

The negative electrode 10 may be formed in the following manner.

First, a negative electrode mixed agent is prepared by mixing the negative electrode active material used for the first layer 12A and a bonding agent made of a fluorine-based high-molecular binder resin, and the negative electrode mixed agent is dispersed into a solvent such as N-methyl-2-pyrrolidone to dorm paste-like negative electrode mixed agent slurry.

Subsequently, after the negative electrode mixed agent slurry is applied over the negative electrode current collector 11 and the solvent is dried, the first layer 12A of the negative electrode active material layer 12 is formed by compressed molding.

Next, a negative electrode mixed agent is prepared by mixing the negative electrode active material used for the second layer 12B and a bonding agent formed of a fluorine-based high-molecular binder resin, and the negative electrode mixed agent is dispersed into a solvent such as N-methyl-2-pyrrolidone to form paste-like negative electrode mixed agent slurry.

Subsequently, after the negative electrode mixed agent slurry is applied over the first layer 12A and the solvent is dried, the second layer 12B of the negative electrode active material layer 12 is formed by compressed molding.

As described above, the first layer 12A of the negative electrode active material layer 12 is formed on the negative electrode current collector 11 to prepare the second layer 12B formed on the first layer 12A, thereby producing the negative electrode 10.

It is preferable that the positive electrode current collector 21 have excellent electrochemical stability, electric conductivity and mechanical strength, which is formed of a metal material such as aluminum, nickel, or stainless steel.

The positive electrode active material layer 22 is preferably includes at least one type of the positive electrode active materials capable of inserting and extracting lithium, to which an electroconductive agent such as carbon, and a binder such as polyvinylidenefluoride or styrene-butadiene resin may optionally be added.

Examples of the materials for the positive electrode active material layer 22 capable of inserting and extracting lithium include a variety of oxides such as manganese dioxide, lithium-manganese composite oxide, lithium-containing nickel oxide, lithium-containing cobalt oxide, lithium-containing nickel-cobalt oxide, lithium-containing iron oxide and lithium-containing vanadium oxide, and chalcogen compounds such as titanium disulfide, and molybdenum disulfide.

Further, it is preferable that lithium-containing metal composite oxides such as lithium-containing cobalt oxide, lithium-containing nickel-cobalt oxide and lithium-manganese composite oxide be used owing to obtaining high voltage. As the positive electrode active material, one type of oxides may be used alone, or two or more types of oxides may be used in combination.

As the lithium-containing metal composite oxides, LiCoO₂, LiNiO₂, LiNi_{0.8}Co_{0.2}O₂, LiMnO₂ and LiMn₂O₄ are preferably used, or two or more types of oxides may be used in combination.

The positive electrode 20 may be formed in the following manner. After mixing the positive electrode active material, an electroconductive agent and a binder, the mixture is dispersed into a solvent such as N-methyl-2-pyrrolidone to form mixed agent slurry. After the mixed agent slurry is applied over the positive electrode current collector 21 in the form of belt-like metal foil and dried, the positive electrode active material layer 22 is formed by compressed molding.

The positive electrode lead 31 and the negative electrode lead 32 leads from inside to extend outside the exterior member 40 in the same direction, for example.

The positive electrode lead 31 and the negative electrode lead 32 are formed of a metal material such as aluminum, copper, nickel, stainless steel, and the like in the form of thin plates or mesh.

The gel-form electrolyte 35 is formed a non-aqueous solvent, an electrolytic salt and a polymer.

Of these, the electrolytic salt and the non-aqueous solvent that are generally used in non-aqueous electrolytic solution secondary batteries for insertion/extraction with lithium on electrodes utilized for battery reaction may be used.

Examples of the non-aqueous solvent include propylene carbonate, ethylene carbonate, diethyl carbonate, dimethyl carbonate, 1,2-dimethoxyethane, 1,2-diethoxyethane, tetrahydrofuran, 2-methyltetrahydrofuran, 1,3-dioxolan, 4methyl1,3dioxolan, diethyl ether, sulfolane, methylsulfolane, acetonitrile, propionitrile, acetic acid ester, butyric acid ester, propionic acid ester, and the like.

The non-aqueous solvents may be used independently, or in combination of two or more. Specifically, a high-boiling solvent is preferably contained in view of stability at high temperatures.

Examples of the electrolytic salt include LiClO₄, LiAsF₆, LiPF₆, LiBF₄, LiB(C₆H₅)₄, CH₃SO₃Li, CF₃SO₃Li, LiCl, LiBr, LiN(CF₃SO₂)₂, and the like.

Here, the gel-form electrolyte 35 is located between the negative electrode 10 and the positive electrode 20 as described above. In this case, the gel-form electrolyte 35 may be used as a separator; however, alternatively, another separator may be used when the negative electrode 10, a gel-form electrolyte 35, the separator, a gel-form electrolyte 35 and the positive electrode 20 are stacked in this order.

The separator separates the positive electrode from the negative electrode to prevent a short circuit of an electric current caused when the both electrodes mutually contact, thereby passing lithium ions through either of the electrodes at charge and discharge. The separator may be formed of a porous film including polyethylene, polypropylene, and the like.

Although the gel-form electrolyte 35 is used in an embodiment of the present invention, a non-aqueous electrolytic solution containing electrolytic salt or a solid electrolyte containing electrolytic salt may be used in the place of the gel-form electrolyte 35.

As the non-aqueous electrolytic solution containing electrolytic salt, the electrolytic salts may be used in combination of the non-aqueous solvents.

As the solid electrolyte, either of inorganic solid electrolytes and high-molecular solid electrolytes may be used provided that the inorganic solid electrolytes and the high-molecular solid electrolytes include lithium-ion conductivity. Examples of the inorganic solid electrolytes include lithium nitride and lithium iodide. The high-molecular solid electrolytes may be formed of electrolytic salts and high-molecular compounds dissolving the electrolytic salts. In the high-molecular compounds, ether-based polymers such as poly(ethylene oxide) and cross-links of the poly(ethylene oxide), ester-based polymers such as poly(methacrylate), acrylate, and the like may be used alone or copolymerized in molecules or used in combination.

The exterior member 40 includes a rectangular aluminum laminated film having a nylon film, aluminum leaf and a polyethylene film stacked with adhesion in this order from outermost layer.

The exterior member 40 is provided such that the polyethylene film side faces the electricity-generating element 30, and the outer edges of the exterior member 40 are mutually adhered with hot melt-adhesion or an adhesive.

A material having adhesiveness such as a polyolefin resin including polyethylene, polypropylene, modified polyethylene, modified polypropylene or the like is inserted between the exterior member 40 and the leads 31, 32 as an adhesive film 41 to encapsulate the exterior member 40.

The exterior member 40 may be formed of a laminated film having a different structure, a high-molecular film such as polypropylene, or a metal film in the place of the aluminum laminated film.

Although the above-mentioned film-form container illustrated in FIG. 1 is used the exterior member 40, an iron can, an aluminum can, or the like may also be used in the place of the film-form container.

The secondary battery 50 may be produced in the following manner.

First, the leads 31, 32 are welded to edges of the current collectors 11 and 21 of the respective negative and positive electrodes 10 and 20 formed of a metal foil. Subsequently, the electricity-generating element 30 includes the negative and positive electrodes 10 and 20 to which the leads 31, 32 have been attached, and the surfaces of the negative and positive electrodes 10 and 20 are mutually faced via the gel-form electrolyte 35.

Next, the electricity-generating element 30 is contained in the exterior member 40, and outer edges of the exterior member 40 are sealed with hot melt-bond to encapsulate the electricity-generating element 30. At this time, the adhesive film 41 is inserted between the leads 31, 32 and the exterior member 40. Accordingly, the secondary battery 50 illustrated in FIG. 1 is completed.

Since the secondary battery 50 employs the aforementioned negative electrode, the second layer 12B formed of a carbon material having a relatively large specific surface area of the carbon material are provided in the secondary battery, thereby controlling precipitation of lithium on the surface of the negative electrode 10 to improve cycle characteristics.

Since the first layer 12A formed of a carbon material having a small specific surface area is provided on the negative electrode current collector 11 side of the negative electrode 10, the specific surface area of the entire negative electrode 10 becomes small, thereby preventing an decrease in safety.

Embodiments of the present invention will be described by way of Examples.

### EXAMPLE 1

First, a positive electrode 20 was produced in the following manner.

A positive electrode mixed agent was prepared by mixing 91 wt % of LiCoO₂ powder having a particle diameter of 10 μm and a specific surface area of 0.4 m²/g, 6 wt % of graphite used as an electroconductive agent, and 3 wt % of polyvinylidenefluoride used as a bonding agent.

The positive electrode mixed agent was then dispersed into N-methyl-2-pyrrolidone to form slurry. Further, the slurry positive electrode mixed agent was uniformly applied to one surface of an aluminum foil having a thickness of 20 μm and then dried to form a positive electrode current collector 21. The positive electrode current collector 21 was then compression molded with a roll press to form a positive electrode active material layer 22, thereby producing a positive electrode 20.

Next, a negative electrode 10 was produced in the following manner.

First, coke and pitch were mixed and the resultant product was then heat-treated to produce a carbon molded body. The carbon molded body was heated at 2800° C. under inert atmosphere to form a graphitized molded body. The graphitized molded body was pulverized and classified to form artificial graphite powder having an average particle diameter of 25 μm and a specific surface area of 0.5 m²/g.

A negative electrode mixed agent was prepared by mixing 90 wt % of the graphite powder and 10 wt % of polyvinylidenefluoride used as a bonding agent. The negaqtive electrode mixed agent was then dispersed into N-methyl-2-pyrrolidone to form slurry.

Further, the slurry negative electrode mixed agent was uniformly applied to one surface of a copper foil having a thickness of 20 μm and then dried to form a negative electrode current collector 11. The negative electrode current collector 11 was then compression molded with a roll press to form a first layer 12A having a thickness of 30 μm.

A negative electrode mixed agent was prepared by mixing 90 wt % of artificial graphite powder having an average particle diameter of 22 μm and a specific surface area of 1.2 m²/g and 10 wt % of polyvinylidenefluoride used as a bonding agent. The negative electrode mixed agent was then dispersed into N-methyl-2-pyrrolidone to form slurry.

Further, the slurry negative electrode mixed agent was uniformly applied to the first layer 12A formed on the negative electrode current collector 11, dried, and then compression molded with a roll press to form a second layer 12B, thereby producing a negative electrode 10.

A gel-form electrolyte 35 was prepared in the following manner.

First, a plasticizing agent was prepared by mixing 12.5 wt % of ethylene carbonate, 12.5 wt % of propylene carbonate, and 5 wt % of LiPF₆ used as an electrolytic salt. 10 wt % of block copolymerization polyvinylidenefluoride-co-hexafluoropropylene having a molecular weight of 600000 and 60 wt % of diethyl carbonate were added to the plasticizing agent and dissolved.

Next, the resultant mixture was uniformly applied to one surface of a negative electrode active material layer 12 and one surface of a positive electrode active material layer 22 for impregnation. The resultant mixture was then allowed to stand for eight hours at a normal temperature to vaporize and eliminate diethyl carbonate, thereby forming a gel-form electrolyte 35.

Finally, gel-form electrolyte 35 surfaces of the positive electrode active material layer 22 and the negative electrode active material layer 12 were mutually faced and then pressure bonded, thereby producing an electricity-generating element 30.

Having inserting the electricity-generating element 30 into an exterior member 40 formed of a moisture-proof aluminum laminated film having a thickness of 180 μm, the exterior member 40 was sealed under reduced pressure to form a secondary battery having dimensions approximately 2.5 cm×4.0 cm×0.46 mm of Example 1 that has the same structure as the secondary battery 50 shown in FIGS. 1 and 2.

### EXAMPLE 2

A secondary battery according to Example 2 was produced in the same manner as Example 1 except that a first layer 12A having a thickness of 20 μm was formed by using artificial graphite powder having an average particle diameter of 25 μm and a specific surface area of 0.5 m²/g; and further, a second layer 12B having a thickness of 30 μm was formed by using artificial graphite powder having an average particle diameter of 20 μm and a specific surface area of 3.0 m²/g as a negative electrode active material layer 12.

### EXAMPLE 3

A secondary battery according to Example 3 was produced in the same manner as Example 1 except that a first layer 12A having a thickness of 25 μm was formed by using artificial graphite powder having an average particle diameter of 25 μm and a specific surface area of 0.5 m²/g; and further, a second layer 12B having a thickness of 25 μm was formed by using artificial graphite powder having an average particle diameter of 20 μm and a specific surface area of 3.0 m²/g as a negative electrode active material layer 12.

### EXAMPLE 4

A secondary battery according to Example 4 was produced in the same manner as Example 1 except that a first layer 12A having a thickness of 30 μm was formed by using artificial graphite powder having an average particle diameter of 25 μm and a specific surface area of 0.5 m²/g; and further, a second layer 12B having a thickness of 20 μm was formed by using artificial graphite powder having an average particle diameter of 20 μm and a specific surface area of 3.0 m²/g as a negative electrode active material layer 12.

### EXAMPLE 5

A secondary battery according to Example 5 was produced in the same manner as Example 1 except that a first layer 12A having a thickness of 35 μm was formed by using artificial graphite powder having an average particle diameter of 25 μm and a specific surface area of 0.5 m²/g; and further, a second layer 12B having a thickness of 15 μm was formed by using artificial graphite powder having an average particle diameter of 20 μm and a specific surface area of 3.0 m²/g as a negative electrode active material layer 12.

### Example 6

A secondary battery according to Example 6 was produced in the same manner as Example 1 except that a first layer 12A having a thickness of 45 μm was formed by using artificial graphite powder having an average particle diameter of 25 μm and a specific surface area of 0.5 m²/g; and further, a second layer 12B having a thickness of 5 μm was formed by using artificial graphite powder having an average particle diameter of 20 μm and a specific surface area of 3.0 m²/g as a negative electrode active material layer 12.

### EXAMPLE 7

A secondary battery according to Example 7 was produced in the same manner as Example 1 except that a first layer 12A having a thickness of 30 μm was formed by using artificial graphite powder having an average particle diameter of 25 μm and a specific surface area of 0.5 m²/g; and further, a second layer 12B having a thickness of 20 μm was formed by using artificial graphite powder having an average particle diameter of 15 μm and a specific surface area of 6.0 m²/g as a negative electrode active material layer 12.

### EXAMPLE 8

A secondary battery according to Example 8 was produced in the same manner as Example 1 except that a first layer 12A having a thickness of 30 μm was formed by using artificial graphite powder having an average particle diameter of 25 μm and a specific surface area of 0.5 m²/g; and further, a second layer 12B having a thickness of 5 μm was formed by using artificial graphite powder having an average particle diameter of 13 μm and a specific surface area of 7.0 m²/g as a negative electrode active material layer 12.

### EXAMPLE 9

A secondary battery according to Example 9 was produced in the same manner as Example 1 except that a first layer 12A having a thickness of 30 μm was formed by using artificial graphite powder having an average particle diameter of 23 μm and a specific surface area of 1.0 m²/g; and further, a second layer 12B having a thickness of 5 μm was formed by using artificial graphite powder having an average particle diameter of 22 μm and a specific surface area of 1.2 m²/g as a negative electrode active material layer 12.

### EXAMPLE 10

A secondary battery according to Example 10 was produced in the same manner as Example 1 except that a first layer 12A having a thickness of 30 μm was formed by using artificial graphite powder having an average particle diameter of 23 μm and a specific surface area of 1.0 m²/g; and further, a second layer 12B having a thickness of 20 μm was formed by using artificial graphite powder having an average particle diameter of 20 μm and a specific surface area of 3.0 m²/g as a negative electrode active material layer 12.

### EXAMPLE 11

A secondary battery according to Example 11 was produced in the same manner as Example 1 except that a first layer 12A having a thickness of 30 μm was formed by using artificial graphite powder having an average particle diameter of 23 μm and a specific surface area of 1.0 m²/g; and further, a second layer 12B having a thickness of 20 μm was formed by using artificial graphite powder having an average particle diameter of 20 μm and a specific surface area of 6.0 m²/g as a negative electrode active material layer 12.

### EXAMPLE 12

A secondary battery according to Example 12 was produced in the same manner as Example 1 except that a first layer 12A having a thickness of 30 μm was formed by using artificial graphite powder having an average particle diameter of 21 μm and a specific surface area of 1.5 m²/g; and further, a second layer 12B having a thickness of 20 μm was formed by using artificial graphite powder having an average particle diameter of 20 μm and a specific surface area of 3.0 m²/g as a negative electrode active material layer 12.

### COMPARATIVE EXAMPLE 1

A negative electrode mixed agent was prepared by mixing 90 wt % of mixed powder including artificial graphite powder having an average particle diameter of 25 μm with a specific surface area of 0.5 m²/g and artificial graphite powder having an average particle diameter of 20 μm with a specific surface area of 3.0 m²/g in a weight ratio of one to one, with 10 wt % of polyvinylidenefluoride used as a bonding agent.

The negative electrode mixed agent was then dispersed into N-methyl-2-pyrrolidone to form slurry. The slurry was uniformly applied to one surface of strip-shaped copper foil having a thickness of 20 μm and then dried to form a negative electrode current collector.

The negative electrode current collector was then compression molded with a roll press to form a negative electrode active material layer 12 having a thickness of 50 μm (corresponding to the first layer 12A in Example 1), thereby producing a secondary battery according to Comparative Example 1, which was produced in the same manner as Example 1 except that a second layer 12B was not formed.

### COMPARATIVE EXAMPLE 2

A secondary battery according to Comparative Example 2 was produced in the same manner as Example 1 except that a first layer 12A having a thickness of 30 μm was formed by using artificial graphite powder having an average particle diameter of 20 μm and a specific surface area of 3.0 m²/g; and further, a second layer 12B having a thickness of 20 μm was formed by using artificial graphite powder having an average particle diameter of 25 μm and a specific surface area of 0.5 m²/g as a negative electrode active material layer 12.

### COMPARATIVE EXAMPLE 3

A secondary battery according to Comparative Example 3 was produced in the same manner as Example 1 except that a first layer 12A having a thickness of 25 μm was formed by using artificial graphite powder having an average particle diameter of 20 μm and a specific surface area of 3.0 m²/g; and further, a second layer 12B having a thickness of 25 μm was formed by using artificial graphite powder having an average particle diameter of 25 μm and a specific surface area of 0.5 m²/g as a negative electrode active material layer 12.

### COMPARATIVE EXAMPLE 4

A secondary battery according to Comparative Example 4 was produced in the same manner as Example 1 except that a first layer 12A having a thickness of 47 μm was formed by using artificial graphite powder having an average particle diameter of 25 μm and a specific surface area of 0.5 m²/g; and further, a second layer 12B having a thickness of 3 μm was formed by using artificial graphite powder having an average particle diameter of 20 μm and a specific surface area of 3.0 m²/g as a negative electrode active material layer 12.

Charge-discharge cycle characteristics and safety on the secondary batteries produced in the Examples 1 to 12 and Comparative Examples 1 to 4 were evaluated based on the method illustrated below.

<Charge-Discharge Cycle Characteristics>

A charge-discharge test was preformed on the secondary batteries produced at a temperature of 25° C.

The battery was charged with a constant current of 0.2 C until the battery voltage was 4.2 V only in charge and discharge at a first cycle, and additionally charged with a constant voltage of 4.2 V for 10 hours. Subsequently, the battery was discharged with a constant current of 0.2 C until the battery voltage was 3.0 V.

From a second cycle onward, the battery was charged with a constant current of 1.5 C until the battery voltage was 4.2 V, and further charged with a constant voltage of 4.2 V for 2.5 hours. A 500 charge-discharge cycle test where the battery was discharged with a constant current of 1 C until the battery voltage was 3.0 V.

The capacity retention rate (%) was calculated as a rate of the discharge capacity at a 500th cycle to the discharge capacity a first cycle, that is:
(discharge capacity at 500th cycle/discharge capacity at a first cycle)×100(%).

It should be noted that 1.0 C corresponds to a current value if a theoretical capacity is completely discharged in one hour; whereas 0.2 C is a current value if the theoretical capacity is completely discharged in five hours.

<Safety>

The battery was charged until the voltage was 4.2 V with a constant current of 0.2 C and additionally charged with a constant voltage of 4.2 V for 10 hours. Subsequently, the battery was discharged with a constant current of 0.2 C until the battery voltage was 3.0 V.

Next, the battery was charged with a constant current of 1.0 C until the battery voltage was 4.3 V, and additionally charged with a constant voltage of 4.3 V for 2.5 hours.

A nail having a diameter of 2.5 mm was penetrated through the center of the battery charged with the above condition, and the safety of the battery was evaluated.

The safety was evaluated as follows.

Accepted: neither ignition nor a spout of gas observed when penetrating the nail through the center of the battery.

Failed: ignition or a spout of gas when penetrating the nail through the center of the battery.

The identical test was carried out on five batteries. The results is on the basis of (number of passes/number of tests).

Table 1 shows the results on the battery test obtained from Examples 1 to 12 and Comparative Examples 1 to 4, representing:

the specific surface area (m²/g) of the carbon materials used for the first layers 12A of the negative electrode active material layers 12;

the thickness (μm) of the first layers 12A; and

the thickness (%) of the first layers 12A corresponding to

the thickness of the entire negative electrode active material layers 12;

the specific surface area (m²/g) of the carbon materials used for the second layers 12B; and

the thickness (μm) of the second layers 12B.

Table 1 also shows evaluation based on the results of the capacity retention rate (%) and the safety (number of passes/number of tests) obtained in Examples 1 to 12 and Comparative Examples 1 to 4.

TABLE 1

| | First Layer 12A | | | Second Layer 12B | | | Safety |
|---|---|---|---|---|---|---|---|
| | Specific | | | Specific | | | Test |
| | Surface | | | Surface | | Capacity | (number of |
| | Area | Thickness | | Area | Thickness | retention | passes/number |
| | (m²/g) | (μm) | (%) | (m²/g) | (μm) | rate (%) | of tests) |
| Example 1 | 0.5 | 30 | 60 | 1.2 | 20 | 75 | 5/5 |
| Example 2 | 0.5 | 20 | 40 | 3.0 | 30 | 83 | 4/5 |
| Example 3 | 0.5 | 25 | 50 | 3.0 | 25 | 82 | 5/5 |
| Example 4 | 0.5 | 30 | 60 | 3.0 | 20 | 80 | 5/5 |
| Example 5 | 0.5 | 35 | 70 | 3.0 | 15 | 73 | 5/5 |
| Example 6 | 0.5 | 45 | 90 | 3.0 | 5 | 70 | 5/5 |
| Example 7 | 0.5 | 30 | 60 | 6.0 | 20 | 85 | 5/5 |
| Example 8 | 0.5 | 30 | 60 | 7.0 | 20 | 85 | 0/5 |
| Example 9 | 1.0 | 30 | 60 | 1.2 | 20 | 76 | 5/5 |
| Example 10 | 1.0 | 30 | 60 | 3.0 | 20 | 82 | 5/5 |
| Example 11 | 1.0 | 30 | 60 | 6.0 | 20 | 86 | 5/5 |
| Example 12 | 1.5 | 30 | 60 | 3.0 | 20 | 82 | 2/5 |
| Comparative | 0.5, 3.0 | 50 | — | — | — | 60 | 5/5 |
| Example 1 | | | | | | | |
| Comparative | 3.0 | 30 | 60 | 0.5 | 20 | 40 | 5/5 |
| Example 2 | | | | | | | |
| Comparative | 3.0 | 25 | 50 | 0.5 | 25 | 50 | 5/5 |
| Example 3 | | | | | | | |
| Comparative | 0.5 | 47 | 94 | 3.0 | 3 | 55 | 5/5 |
| Example 4 | | | | | | | |

Table 1 shows that in Examples 1 to 12, the specific surface area of the carbon materials used for the second layers 12B of the negative electrode active material layers 12 is larger than the specific surface area of the carbon materials used for the first layers 12A; and the thickness of the first layers 12A corresponds to from 40% or more to 90% or less of that of the entire negative electrode active material layers 12. The capacity retention rate after 500 cycles was 70% or more. Thus, excellent results were obtained in all the Examples.

Further, in the carbon materials used in the first layers 12A and the second layers 12B, the larger the specific surface area of the carbon materials used is, the greater the capacity retention rate is likely to be obtained.

In contrast, in Comparative Example 1 where the negative electrode active material layer 12 is formed by mixing two types of artificial graphite powder, each having different in specific surface area, the capacity retention rate after 500 cycles decreases to 60%.

In Comparative Examples 2 and 3, where the specific surface area of the carbon materials used for the second layers 12B of the negative electrode active material layers 12 is smaller than the specific surface area of the carbon materials used for the first layers 12A, the capacity retention rate decreases compared to the respective capacity retention rates obtained in Examples 3 and 4, where the thickness of the first layers 12A and the thickness of the second layers 12B are the same as those in Comparative Examples 2 and 3.

Therefore, it is suggested that a negative electrode active material layer 12 include a first layer 12A and a second layer 12B, and the specific surface area of a carbon material used for the second layer 12B of the negative electrode active material layer 12 be smaller than the specific surface area of a carbon material used for the first layer 12A for improving the capacity retention rate.

In Comparative Example 4 where the thickness of the first layer 12A corresponds to 94% of that of the entire negative electrode active material layer 12, the capacity retention rate decreases compared to the respective capacity retention rates obtained Examples 2 to 6 where the carbon materials used are the same as that used in Comparative Example 4 and the thicknesses of the respective first layers 12A correspond to 40%, 50%, 60%, 70% and 90% of the entire negative electrode active material layer 12.

Therefore, it is suggested that the uppermost limit of the thickness of a first layer 12A be 90% or less of the thickness of a negative electrode active material layer 12.

Further, when Example 2 where the thickness of the first layers 12A corresponds to 40% of the entire negative electrode active material layers 12 is compared with Example 3 where the thickness of the first layers 12A corresponds to 50% of the entire negative electrode active material layers 12, little difference was observed between the two capacity retention rates. However, as can be seen from the results of the safety tests, in Example 2, the result of the safety test (number of passes/number of tests) obtained was 4/5, representing the safety in Example 2 was lower than that in Example 3. Thus, if the thickness of a first layer 12A corresponds to less than 40% of the thickness of the whole of a negative electrode active material layer 12, the safety of a battery decreases.

Therefore, it is suggested that the thickness of a first layer correspond to 40% or more of the thickness of a negative electrode active material layer.

Moreover, in view of the safety of a battery, it is preferable that the result of the safety test be 5/5. Thus, it is preferable that the thickness of a first layer 12A correspond to 50% or more of the thickness of a negative electrode active material layer 12.

Further, when comparing Example 12 the specific surface area of the carbon material used for the first layer 12A is 1.5 m²/g with Example 10 where the specific surface area of the carbon material used for the first layer 12A is 1.0 m²/g, the same capacity retention rates were observed in Example 12 and Example 10; however, the result of the safety test represents a decrease in the safety in Example 12.

When comparing Example 8 where the specific surface area of the carbon material used for the second layer 12B is 7.0 m²/g with Example 7 where the specific surface area of the carbon material used for the second layer 12B is 6.0 m²/g, the same capacity retention rates were observed in Example 8 and Example 7; however, the result of the safety test represents a decrease in the safety in Example 8.

Thus, if the specific surface area of a carbon material used for a first layer 12A exceeds 1.0 m²/g, or the specific surface area of a carbon material used for a second layer 12B exceeds 6.0 m²/g, the safety of a battery may decrease.

Therefore, it is preferable that the specific surface area of a carbon material forming a first layer 12A be 1.0 m²/g or less.

Further, it is preferable that the specific surface area of a carbon material forming a second layer 12B be 6.0 m²/g or less.

It should be noted that the aforementioned safety test was performed under an adverse condition where a nail penetrated through the center of the battery. Thus, there is little possibility that ignition or a spout of gas occur if the battery is used under a normal condition. It may also be possible to improve the safety of the battery by adding some devices to other portions of the battery than the negative electrode 10. Accordingly, Examples 2, 8 and 10 are involved within the scope of the present invention. The use of the negative electrodes in other Examples may improve the safety, and hence some device in the configuration of the battery may be omitted for improving the safety, thereby simplifying the configuration of the battery, and increasing a degree of freedom.

So far, the embodiments and Examples of the present invention have been described above; however, a secondary battery according to the embodiments of the present invention are not limited thereto, and various modifications and alternative forms may be applied.

Further, in a secondary battery according to the embodiments of the present invention, the shapes of the battery are not limited thereto; however, the shapes of the battery may be formed of any arbitrary shapes including a cylindrical type, an angular type, a coin type, a button type, a laminated sheet type, and the like. Specifically, there may exhibit effectiveness with a non-aqueous electrolyte secondary battery having a laminated film used as an exterior material.

In addition, the secondary batteries having gel-form electrolytes have been described in the aforementioned embodiments and Examples. However, as a method of producing an electricity-generating element having the negative and positive electrodes in combination, a method of winding the positive and negative electrodes having a separator inbetween around a winding core; a method of stacking the electrodes and separators are alternately stacked in series, and the like may be given. Moreover, for producing a thin battery or an angular battery, the aforementioned method of winding the electrodes with a separator inbetween may be employed.

The gel-form electrolyte batteries have been described in the above-mentioned embodiments and Examples; however, in the electrode of a secondary battery according to the embodiments of the present invention, the shapes of the electrode are not limited thereto; however, the shapes of the electrode may be formed of any arbitrary shapes including a cylindrical type, an angular type, a coin type, a button type, a laminated sheet type, and the like.

It is not that the present invention is confined to the above-mentioned structures but that various other structures are possible without deviating from the gist of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A negative electrode comprising:
a negative electrode current collector; and
a negative electrode active material layer provided on the negative electrode current collector, wherein
the negative electrode active material layer includes a first layer having contact with the negative electrode current collector, and a second layer formed on the first layer;
the first and second layers are formed of carbon materials capable of inserting and extracting lithium;
a specific surface area of a carbon material forming the second layer is larger than a specific surface area of a carbon material forming the first layer; and
a thickness of the first layer corresponds to from 40% or more to 90% or less of a thickness of the entire negative electrode active material layer.

2. A negative electrode according to claim 1, wherein the thickness of the first layer corresponds to from 50% or more to 90% or less of the thickness of the entire negative electrode active material layer.

3. A negative electrode according to claim 1, wherein the specific surface area of the carbon material forming the first layer is 1.0 m²/g or less.

4. A negative electrode according to claim 1, wherein the specific surface area of the carbon material forming the second layer is larger than 1.0 m²/g and 6.0 m²/g or less.

5. A secondary battery comprising:
a positive electrode,
a negative electrode and
an electrolyte, wherein
the negative electrode is includes a negative electrode current collector and a negative electrode active material layer;
the negative electrode active material layer includes a first layer having contact with the negative electrode current collector and a second layer formed on the first layer;
the first and second layers are formed of carbon materials capable of inserting and extracting lithium;
the specific surface area of the carbon material forming the second layer is larger than the specific surface area of the carbon material forming the first layer; and
the thickness of the first layer corresponds to from 40% or more to 90% or less of the thickness of the entire negative electrode active material layer.

6. A secondary battery according to claim 5, wherein the thickness of the first layer corresponds to from 50% or more to 90% or less of the thickness of the entire negative electrode active material layer.

7. A secondary battery according to claim 5, wherein the specific surface area of the carbon material forming the first layer is 1.0 m²/g or less.

8. A secondary battery according to claim 5, wherein the specific surface area of the carbon material forming the second layer is larger than 1.0 m²/g and 6.0 m²/g or less.
